(19) United States
(12) Patent Application Publication
(10) Pub. No.: US 2005/0247750 A1
(43) Pub. Date: Nov. 10, 2005

(54) Integrated air tool and pressure regulator

(76) Inventors: Robert F. Burkholder, Jackson, TN (US); Edward A. Sieberg, Jackson, TN (US); Stephen J. Vos, Jackson, TN (US); Alan Phillips, Jackson, TN (US); Daniel Paxton Wall, Humbolt, TN (US)

Correspondence Address: SUITER WEST SWANTZ PC LLO, 14301 FNB PARKWAY, SUITE 220, OMAHA, NE, 68154, US

(21) Appl. No.: 10/903,507

(22) Filed: Jul. 30, 2004

Related U.S. Application Data
(60) Provisional application No. 60/491,792, filed on Jul. 31, 2003.

(51) Int. Cl. B25C 5/06

(52) U.S. Cl. 227/130; 173/170

(57) ABSTRACT

The integrated air tool and pressure regulator assembly allows several air tools to operate from a single air compressor, using a simplified air hose distribution system. An operator may independently adjust the regulated pressure of the integrated air tool and pressure regulator assembly to compensate for varying working conditions. A greater air hose supply pressure may be used, as regulation of air pressure is accomplished at the integrated air tool and pressure regulator assembly. The increased air transport efficiency allowed by the integrated air tool and pressure regulator assembly of the present invention may provide for the use of smaller diameter hose, which may be lighter, more flexible, less costly, and the like.

### CROSS REFERENCE

The present application claims priority under 35 U.S.C. §119(e) to U.S. Provisional Patent Ser. No. 60/491,792, entitled: Integrated Air Tool and Pressure Regulator, filed on Jul. 31, 2003, which is hereby incorporated by reference in its entirety.

### FIELD OF THE INVENTION

The present invention relates generally to the field of pressure regulators, and more particularly to a pneumatic tool including a pressure regulator assembly wherein a pressure regulator is integrated in the body of a pneumatic tool.

### BACKGROUND OF THE INVENTION

Pneumatic tools utilizing compressed air (air tools) are frequently operated by groups or teams of air tool users sharing a single air compressor assembly and pressure regulator. Supplying several air tools with compressed air from a single air compressor assembly and pressure regulator may be desirable for minimizing equipment costs, reducing the amount of equipment needed in a work area, and the like. For example, a team of workers may use several pneumatic fasteners such as pneumatic fasteners powered by a single air compressor assembly. When working conditions, air tool types, or the like differ between members of a team doing different jobs, however, air pressure requirements may vary for different team members. For instance, a worker using a pneumatic hammer drill may have different air pressure requirements from workers using pneumatic fasteners. As a result, workers utilizing the same compressor may be forced to select a single pressure for all the pneumatic tools operated from the compressor. When team members sharing a single air compressor assembly have differing air pressure requirements, the team may have to add an additional air compressor assembly, an additional pressure regulator and separate air hoses between the air compressor assembly and the work area, and the like. Additional equipment may require additional cost as well as the added expense in time and effort of transporting the additional equipment to and from a job site each day.

### SUMMARY OF THE INVENTION

Consequently, the present invention is directed to a pneumatic tool including a pressure regulator assembly. The integrated pneumatic tool of the present invention allows several air tools to operate from a single air compressor using a simplified distribution system. An operator may independently adjust the regulated pressure of the pneumatic tool to compensate for varying conditions. In an exemplary embodiment, a higher air hose supply pressure may be used, as regulation of air pressure is accomplished at the point of use. Higher pressures may allow the system to deliver air with less pressure loss over a lower pressure system. In addition, the increased air transport efficiency allowed by the pneumatic tool of the present invention may provide for the use of smaller diameter hose, which may be lighter, more flexible, less expensive, promote mobility and the like.

In a first aspect of the invention, a pneumatic tool includes a pneumatic device for performing a task upon application of compressed air. A regulator and coupling are integrated into a tool housing encompassing the pneumatic device such that compressed air entering the pneumatic device is regulated to a pre-selected pressure at the point of use of the pneumatic device.

In a further aspect of the invention, a pneumatic fastener, such as a pneumatic nail gun or a pneumatic staple gun, includes a pneumatic driver for driving a fastener into a workpiece. An adjustable regulator is included in a housing encompassing the pneumatic driver. The regulator is coaxially arranged with a coupling for connecting to a supply of compressed air such as a pneumatic hose connected to a compressor. In an embodiment, the regulator is adjustable via a dial having a set of inwardly extending gear teeth configured to contact with a planet gear which is engagement with a sun gear for operating a valve to change the pressure of air operating the pneumatic driver.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a side view of a pneumatic fastener including an integrated pressure regulator assembly;

FIG. 2 is a partial isometric view of an integrated pressure regulator for utilization with a pneumatic fastener;

FIG. 3 is a partial side view of a pneumatic fastener including pressure regulator assembly;

FIG. 4 is a partial end view of a pneumatic fastener including a pressure regulator;

FIG. 5 is a partial cross-sectional view of a pressure regulator in accordance with an aspect of the present invention;

FIG. 6 is a side view of a pneumatic fastener including a coaxially configured pressure regulator assembly;

FIG. 7 is a partial isometric view of a coaxial integrated pressure regulator for utilization with a pneumatic fastener;

FIG. 8 is a partial cross-sectional view of a coaxial pressure regulator in accordance with an aspect of the present invention;

FIG. 9 is a partial cross-sectional view of a coaxial pressure regulator in accordance with an aspect of the present invention;

FIG. 10 is a partial exploded view of a coaxial pressure regulator assembly in accordance with an embodiment of the present invention;

FIG. 11 is a partial exploded view illustrating a coaxial pressure regulator assembly; and

FIG. 12 is an exploded view of a pneumatic fastener including a coaxial pressure regulator assembly.

### DETAILED DESCRIPTION OF THE INVENTION

Reference will now be made in detail to the presently preferred embodiments of the invention, examples of which are illustrated in the accompanying drawings.

Referring generally to FIGS. 1 through 5, an integrated pneumatic tool and pressure regulator assembly in accordance with an exemplary embodiment of the present invention is described. The integrated pneumatic tool and regulator assembly includes a pneumatic device, a regulator assembly threadably connected to the pneumatic device, and a coupling threadably connected to the regulator assembly for connecting pipes, pressure hoses, tubes, and the like. Suitable pneumatic tools for performing a task include staplers, nailers, sanders, drills, hammering devices, paint guns, impact wrenches, and the like. In the present embodiment, the regulator assembly includes a housing for integrating with the pneumatic device such as by connecting the coupling to the pneumatic device, a plunger which forms a seal to retain a regulated pressure and a bleed-off port, a knob threadably connected to the housing, and a spring compressed between the knob and the plunger. For example, a regulator may be configured to be connected into the pneumatic device/tool housing encompassing the pneumatic device. The plunger abutting the spring may be affixed to a pressure control valve abutting a spring, for maintaining the regulated pressure in proportion to the rotational position of the knob.

Referring generally to FIGS. 1 through 4, a pneumatic fastener 100 in accordance with an embodiment includes a pneumatic fastener driver 102, a pressure regulator assembly 200 threadably connected to the pneumatic driver 102, and a coupling 104 threadably connected to the regulator assembly 200 for coupling to pipes, pressure hoses, tubes, or the like. Those of skill in the art will appreciate a variety of pneumatic devices may be implemented. For example, a pneumatic motor may be utilized for operating a pneumatic random orbit sander. A knob for biasing a pressure control valve of the regulator assembly 200 may include a scale with fixed settings 300. A stop such as a pin 302 may be inserted into a housing of the regulator assembly 200 to limit the rotational range of the knob thereby limiting the obtainable pressure of the valve. Those of skill in the art will appreciate that a wide variety of stop configurations for defining a maximum allowed or acceptable pressure for the power tool. It is the intent of this disclosure to encompass and include such variation.

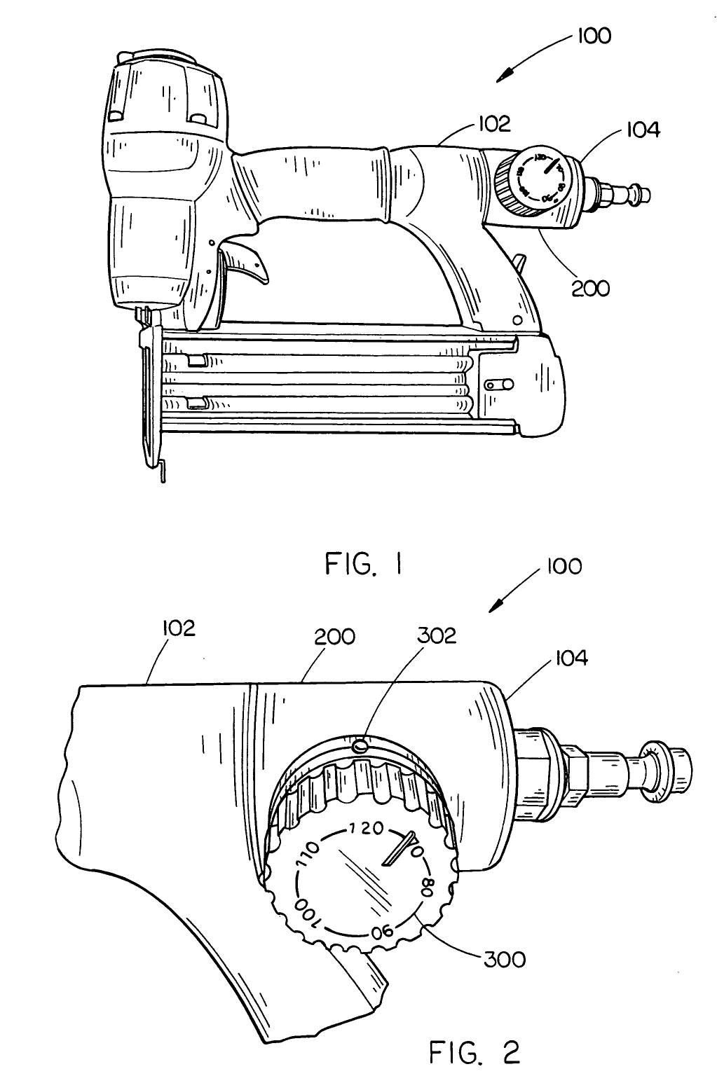

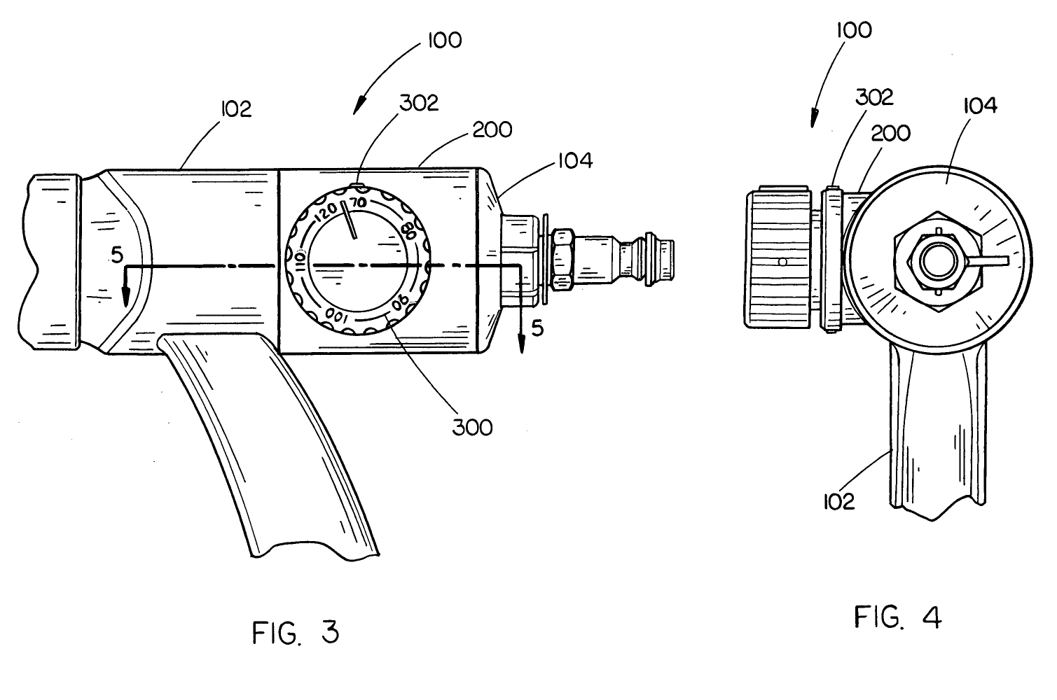

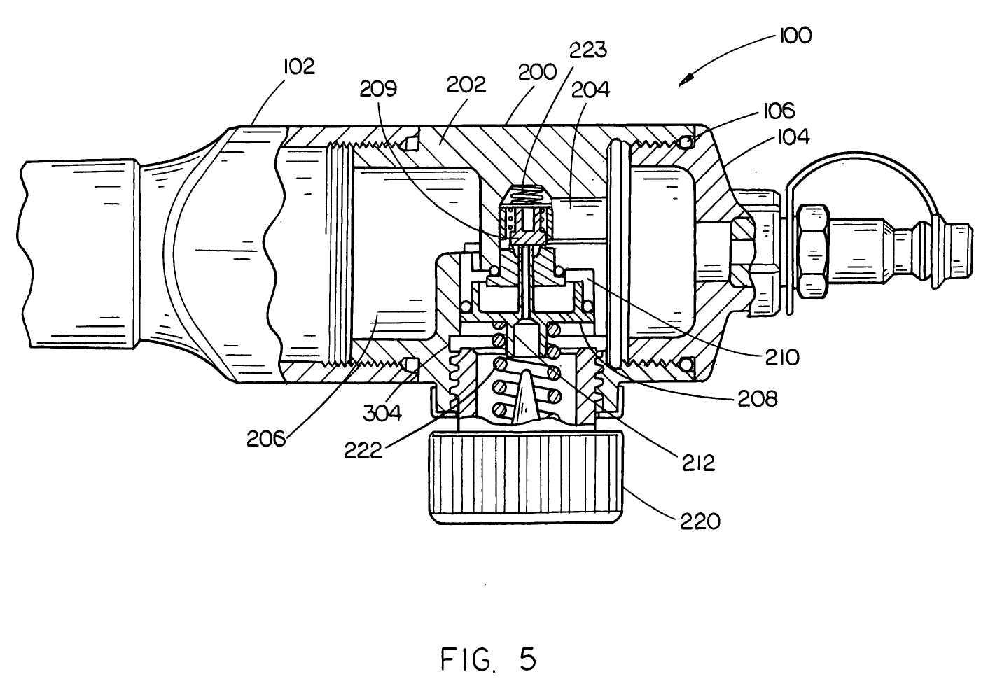

Referring to FIG. 5, a pneumatic fastener 100 in accordance with an exemplary embodiment of the present invention includes a pneumatic driver 102; a pressure regulator assembly 200 threadably integrated into the pneumatic driver 102; and a coupling 104 threadably (i.e. a threaded connection) connected to the pressure regulator assembly 200 and sealed with an O-ring 106, for connecting to pipes, pressure hoses, tubes, and the like. The regulator assembly 200 may include a housing 202 having an intake port 204 and an exhaust port 206, for connecting the coupling 104 and the pneumatic driver 102 respectively; a plunger 208 which forms a seal to retain a regulated pressure and includes a bleed off port 212; a knob 220 threadably connected to the housing 202; and a spring 222 compressed between the knob 220 and the plunger 208. The knob 220 may include a scale with fixed settings 300 (as may be observed in FIGS. 2 and 3). In the current embodiment, a shoulder 304 is connected between the housing 202 and the plunger 208 for limiting the travel range of the plunger 208. In an advantageous example, the plunger 208 abutting the spring 222 is affixed to a pressure control valve 209 abutting a small spring 223 (relative to spring 222). The pressure control valve 209 connected between the small spring 223 and the spring 222 (via the plunger 208) maintains the regulated pressure 210 in proportion to the rotational position of the knob 220. In further embodiments, various pressure regulating devices may be implemented, such as a diaphragm type valve assembly, or the like for regulating the flow of air.

A crank knob 220 or handle may be implemented in substantially the same manner as the knob 220 of the present embodiment. Those of skill in the art will further appreciate that the regulator assembly 200 may include a lever assembly for biasing the pressure control valve 209, the lever being pivotally attached to the housing 202 for compressing the spring 222. In further embodiments, a non-adjustable pressure regulator assembly is utilized. For instance, a fixed regulator for providing a predefined fixed pressure is implemented, in order to minimize ware, for cost effectiveness, and the like. In further embodiments, the pressure adjustment device may be configured to prevent inadvertent adjustment or unauthorized adjustment, such a through utilization of a set screw, a key system, or the like for preventing inadvertent or unauthorized pressure adjustment.

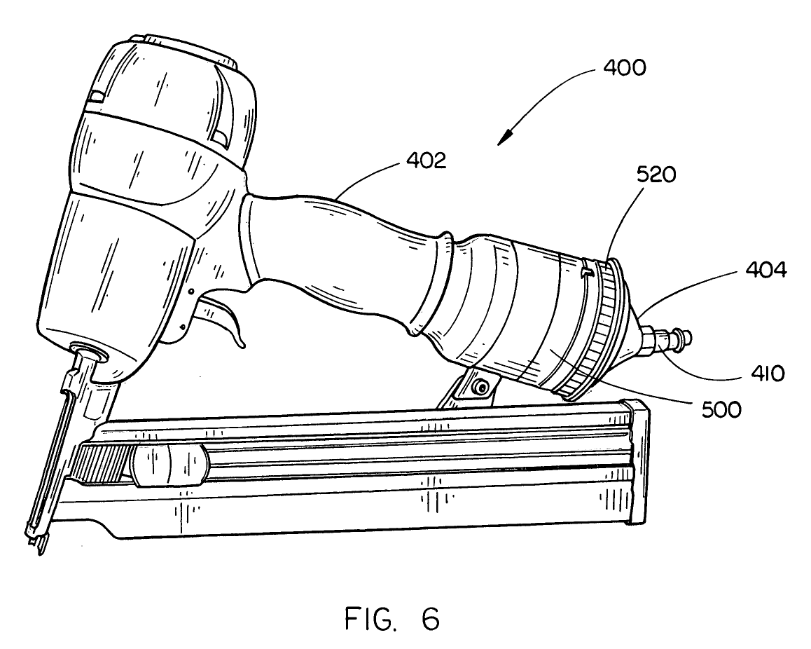

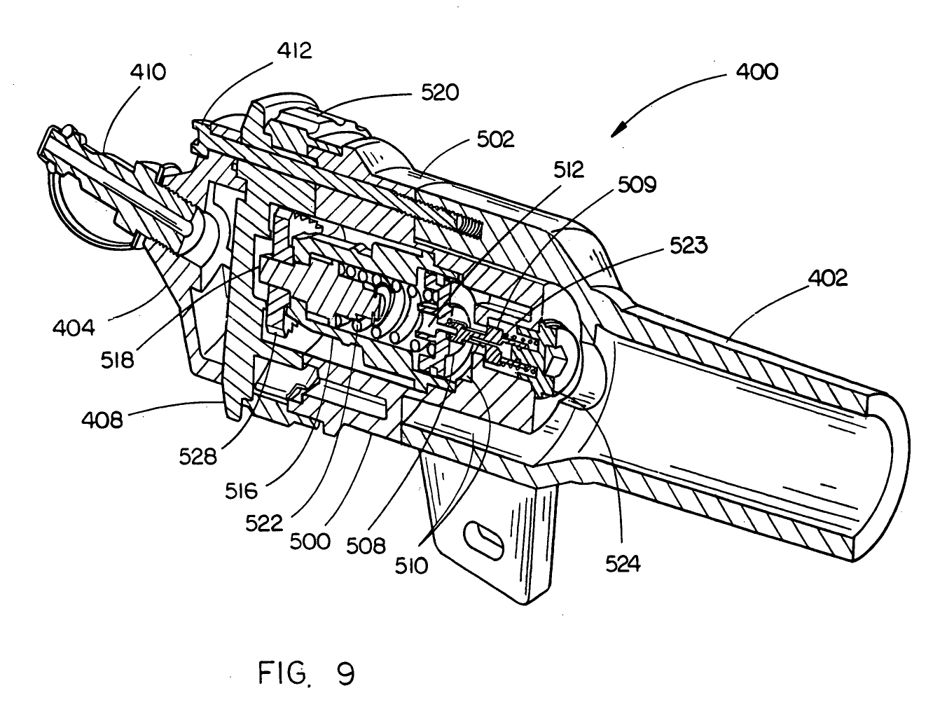

Referring generally now to FIGS. 6 through 12, pneumatic fastener including an integrated pressure regulator assembly in accordance with an embodiment is described. The pneumatic fastener includes a pneumatic driver and a pressure regulator assembly. The pneumatic fastener includes a pressure cap having a coupling device for connecting to pipes, pressure hoses, tubes, and the like. The regulator assembly includes a manifold connected between the pressure cap and the pneumatic device. In exemplary embodiments, the manifold includes components for regulating the pressure of high flow compressed air supplied to the pneumatic fastener. For instance, the manifold may include a sleeve for enclosing high flow pressure regulator components, a plunger which forms a seal to retain a regulated pressure and includes a bleed off port, a screw threadably connected to the sleeve, and a spring compressed between the screw and the plunger. The screw may be coupled with a dial rotationally connected to the manifold via a set of planetary gears or the like, for adjusting the rotational position of the screw by twisting the dial. The plunger abutting the spring may be affixed to a pressure control valve abutting a small spring, for maintaining the regulated pressure in proportion to the rotational position of the dial.

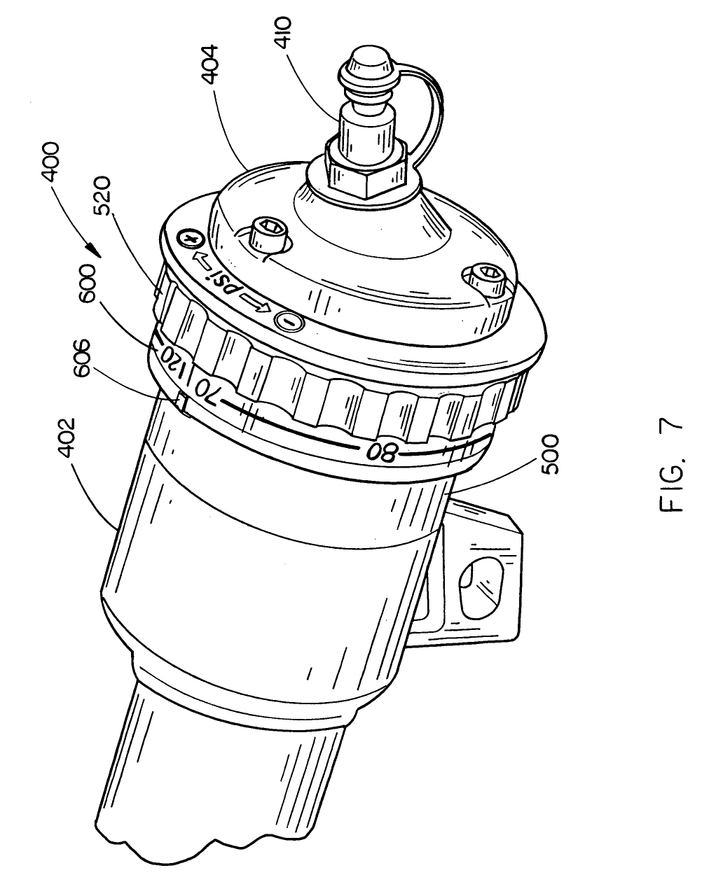

Referring to FIGS. 6 and 7, an integrated pneumatic fastener and regulator assembly 400 in accordance with an exemplary embodiment of the present invention includes a pneumatic fastener assembly 402 and a regulator assembly 500. The pneumatic fastener 402 includes a pressure cap 404 having a coupling device 410 for connecting pipes, pressure hoses, tubes, and the like. A dial 520 for biasing a pressure control valve included in regulator assembly 500 may include a label scale 600 for indicating pressure settings. In exemplary embodiments of the present invention, a setting indicator 606 which may include a decal, a pin, a notch, a ridge, a marking, or the like is affixed to the regulator assembly 500 and paired with the label scale 600 for indicating pressure settings of the dial 520. Alternately, the regulator assembly 500 may include the label scale 600 and the dial 520 may include the setting indicator 606. Those of skill in the art will appreciate that the regulator assembly 500 may include one or more retention pieces including pins, screws, and the like to limit or fix the rotational range of the dial 520 without departing from the scope and intent of the present invention. For example, a pull-out knob may be utilized to prevent inadvertent pressure adjustment.

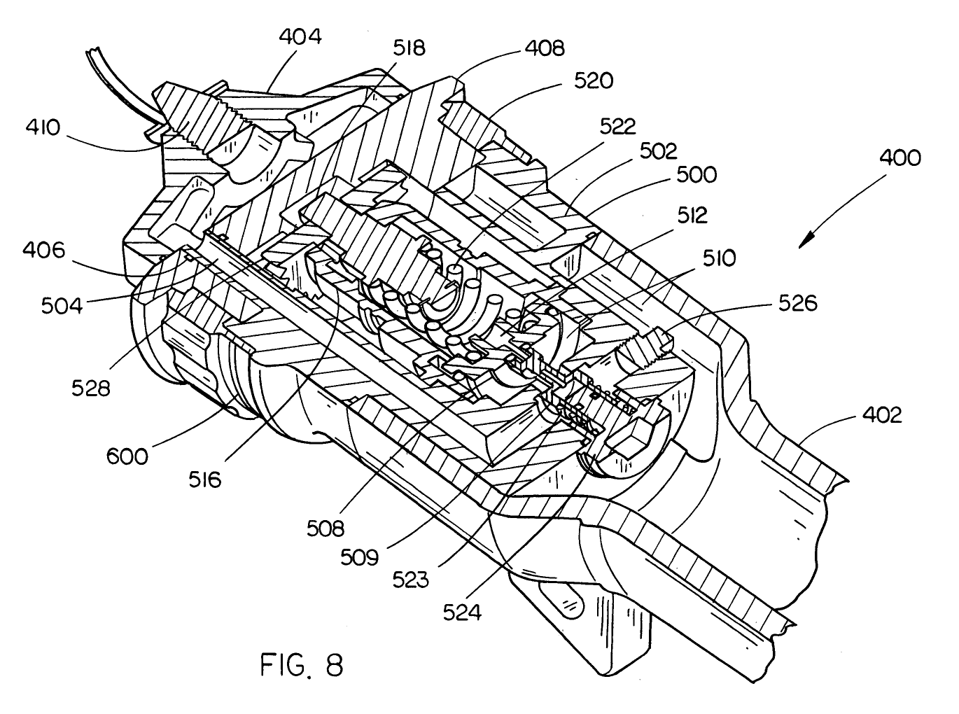

Referring generally now to FIGS. 8 through 12, a pneumatic fastener including an integrated pressure regulator assembly in accordance with an exemplary embodiment of the present invention includes a pneumatic driver 402 and a pressure regulator assembly 500. The pneumatic fastener includes a pressure cap 404 having a coupling for connecting pipes, pressure hoses, tubes, and the like. For example, the coupling is a male quick connect pneumatic coupler 410. Those of skill in the art will appreciate that a variety of coupling devices may be utilized such as a female quick connect pneumatic coupler, threaded couplers, and the like for pneumatically connecting a pneumatic tool to an air source. The pressure regulator assembly 500 includes a manifold 502 including an intake port 504 and an exhaust port 506 (as may be seen in FIG. 12), connected between the pressure cap 404 and the pneumatic driver 402. An intermediate plate 408 for receiving the intake port 504 is connected between the manifold 502 and the pressure cap 404. The intermediate plate 408 is sealed against the pressure cap 404 with an O-ring seal or the like, for supplying an inlet pressure to the intake port 504. The intake port 504 is sealed against the intermediate plate 408 with an O-ring seal 406 or the like, for supplying the inlet pressure to the regulator assembly 500.

In exemplary embodiments, the manifold 502 includes components for regulating the pressure of high flow compressed air supplied to the pneumatic driver 402. For instance, the manifold 502 may include a sleeve 516 for enclosing high flow pressure regulator components, a plunger 508 which forms a seal to retain a regulated pressure 510 and includes a bleed off port 512, a screw 518 threadably connected to the sleeve 516, and a spring 522 compressed between the screw 518 and the plunger 508. The screw 518 may be coupled with a dial 520 rotationally connected to the manifold 502 via a set of planetary gears or the like, for adjusting the rotational position of the screw 518 by rotation of the dial 520.

The plunger 508 abutting the spring 522 may be affixed to a pressure control valve 509 abutting a small spring 523, for maintaining the regulated pressure 510 in proportion to the rotational position of the dial 520. Those of skill in the art will appreciate that the intermediate plate 408, the manifold 502, and/or the dial 520 may include one or more stops such as interference protrusions, teeth, or the like to limit the rotational range of the dial 520 as well. The small spring 523 may be compressed between the pressure control valve 509 and a stop 524 for supporting the small spring 523. The housing 502 may include a plug 526 for sealing one end of the intake port 504, if the intake port 504 is formed generally as an L-shaped passageway through the manifold 502 or the like.

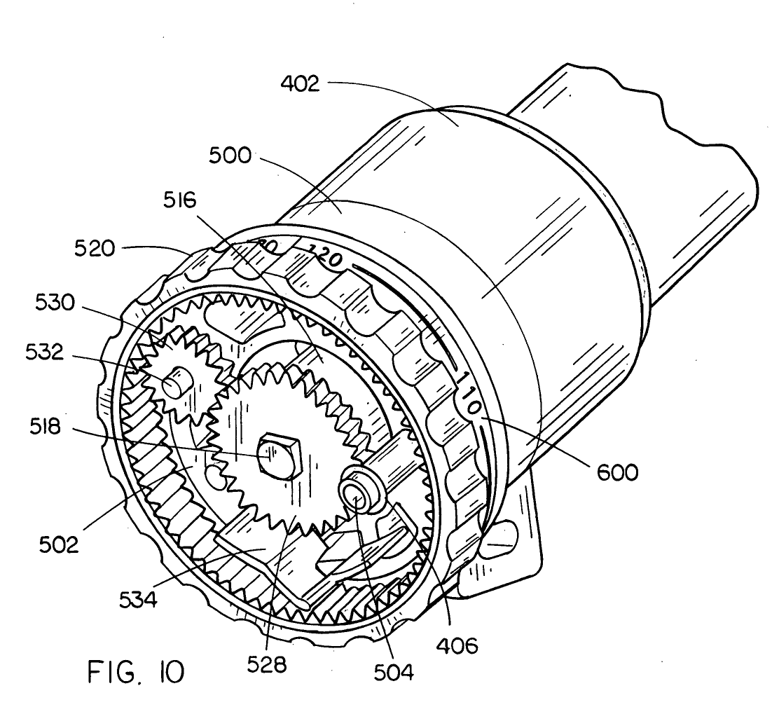

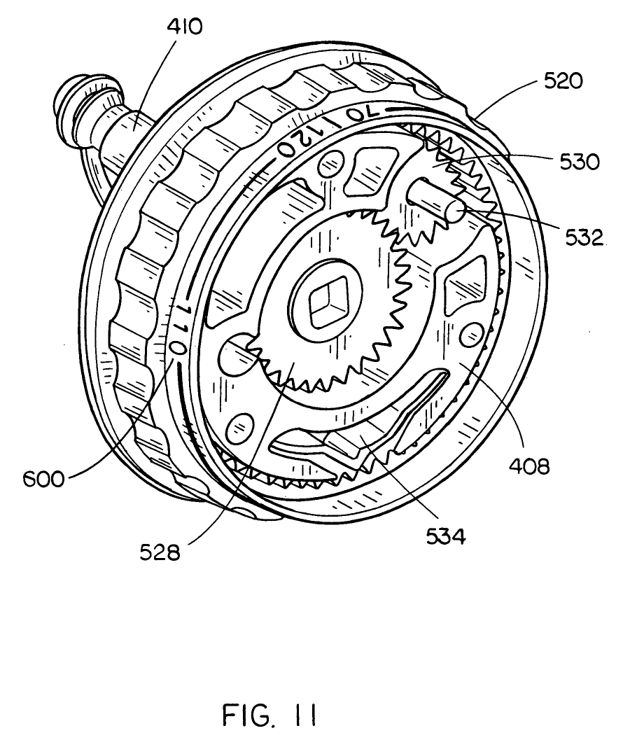

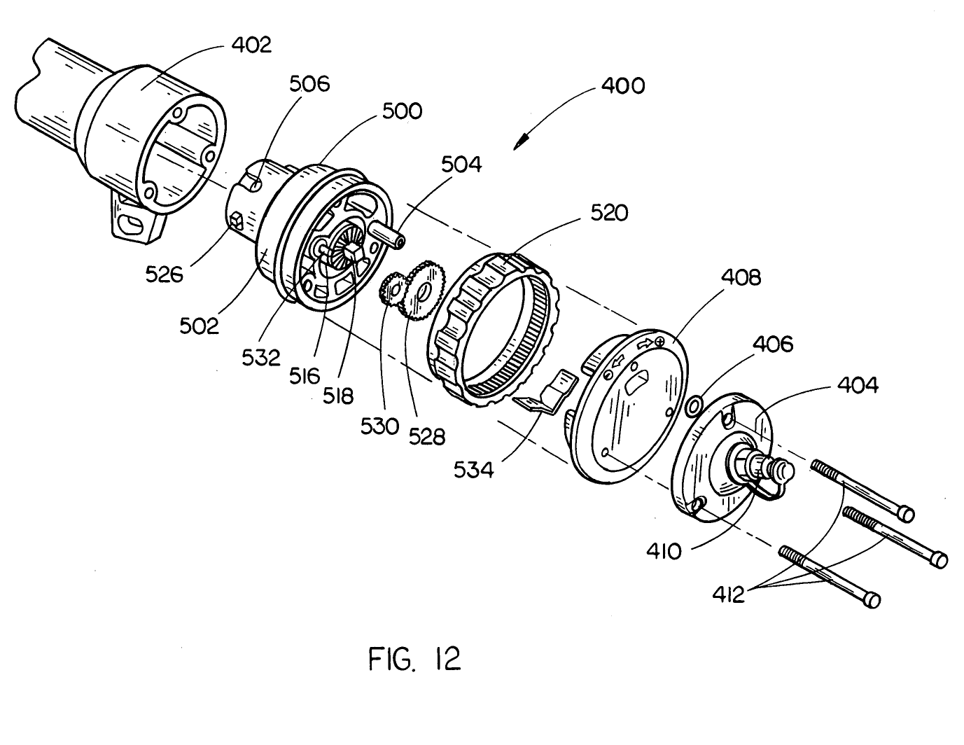

Referring generally to FIGS. 10 and 11, the dial 520 is coupled with the valve screw 518 via a sun gear 528 and a planetary gear 530 in an exemplary embodiment of the present invention. Those of ordinary skill in the art will appreciate that while the screw 518 is threadably connected to the sleeve 516 and rotates in concert with the sun gear 528, the sun gear 528 may be connected to the screw 518 fixedly, slidably, or the like, for remaining substantially in contact with the planet gear 530. For instance, the screw 518 may include a square protrusion upon which the sun gear 528 is slidably mounted, relative to an axis of rotation of the screw 518 and the sun gear 528. In this arrangement, the sun gear 528 may be supported between the intermediate plate 408 and the sleeve 516 for remaining in contact with the planetary gear 530. Alternately, the sun gear 528 may be fixedly connected to the screw 518, and the planetary gear 530 may be of a sufficient thickness for remaining in contact with the sun gear 528 throughout a linear range of travel, relative to an axis of rotation of the screw 518 and the sun gear 528.

The planetary gear 530 is connected between the sun gear 528 and the dial 520, which includes a set of inwardly extending gear teeth about its interior circumference. Rotation of the dial 520 causes rotation of the planetary gear 530 and corresponding rotation of the sun gear 528. In exemplary embodiments of the present invention, the planetary gear 530 is supported between the intermediate plate 408 and the housing 502 with a pin 532 or the like. Alternately the pin 532 may be integrally formed with the housing 502, the intermediate plate 408, or the like. Those of skill in the art will appreciate that various springs having various sizes, spring rates, and stresses; and gears having various ratios; threads having various pitches; and the like may be implemented for varying the magnitude of pressure regulation changes accomplished through rotation of the dial 520, providing mechanical advantage for rotating the screw 518, allowing for finer or coarser adjustment of the screw 518, and the like.

In exemplary embodiments of the present invention, a pneumatic fastener having an integrated pressure regulator assembly 400 may include an indicator for providing signals, such as an audible signals, a tactile signals, a visual signals, or the like (or a combination thereof), for indicating adjustment of the dial 520. Such an indicator may also be used for indicating unwanted movement of the dial 520, for providing a number of discrete incremental adjustment steps for the pressure regulator assembly 500 via the dial 520, for limiting the rotational range of the dial 520, and the like. For instance, a leaf spring 534 including a raised portion for contacting the set of gear teeth about the interior circumference of the dial 520 may be employed for providing audible and/or tactile signals for indicating adjustment of the dial 520, preventing unwanted movement of the dial 520, and providing a number of discrete incremental adjustment steps for the pressure regulator assembly 500 via the dial 520. The leaf spring 534 may be connected between the intermediate plate 408 and the housing 502. Those of skill in the art will appreciate that many various devices for providing signals including audible signals, tactile signals, visual signals, and the like; for preventing unwanted movement of the dial 520; for providing a number of discrete incremental adjustment steps for the pressure regulator assembly 500 via the dial 520; for limiting the rotational range of the dial 520; and the like may be implemented as desired.

Referring to FIG. 12, a pneumatic fastener including an integrated pressure regulator assembly 400, in accordance with an exemplary embodiment, includes threaded pins 412 for connecting the pressure regulator assembly 500 with the pneumatic fastener assembly 402. The threaded pins 412 may extend from the pressure cap 404 through the intermediate plate 408 and the manifold 502, being threadably received by the pneumatic fastener assembly 402. Those of skill in the art will appreciate that a variety of securing devices may be implemented for connecting the regulator assembly 500 with the pneumatic driver 402. For example, the pneumatic driver 402 may threadably receive the regulator assembly 500, the regulator assembly 500 may threadably receive the pneumatic driver 402, the pneumatic driver 402 and the pressure regulator assembly 500 may be connected with bolts or screws, the pneumatic fastener assembly 402 and the pressure regulator assembly 500 may be formed as an integral unit or assembly, and the like.

Further, the pressure regulator assembly 500 may be removably attached to the pneumatic fastener assembly 402. For example, it may be desirable to include the pressure regulator assembly 500 when working with high flow compressed air and to remove the pressure regulator assembly 500 when working with air at a lower pressure. The ability to remove the pressure regulator assembly 500 from the pneumatic fastener assembly 402 may provide for a more flexible tool. It should also be noted that more than one pressure regulator assembly may be provided with an integrated air tool and pressure regulator assembly, in accordance with exemplary embodiments of the present invention. For example, it may be desirable to include a high flow pressure regulator assembly when working with high flow compressed air and to remove the high flow pressure regulator assembly and replace it with a lower flow pressure regulator assembly when working with air at a lower pressure.

Those of skill in the art will appreciate that a plurality of pneumatic tools having integrated regulators may be incorporated into a high pressure system. For example, a system having multiple tools may have a delivery pressure set to at least the pressure requirement for the highest pressure tool. For instance, a system including a first tool having a pressure requirement of 90 psi (pounds per square inch), a second tool having a 125 psi requirement, and a third tool having a 135 psi requirement may have a compressor, or distributed pressure of at least 135 psi. Moreover, a higher delivery pressure (i.e. the pressure delivered to the tool) may minimize air loss during delivery, minimize the size of hose required, promote mobility, and the like.

It is believed that the integrated air tool and pressure regulator assembly of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention to encompass and include such changes. It is the intention of the following claims to encompass and include such changes.

1. A pneumatic tool, comprising:
a pneumatic device constructed to perform a task under the influence of compressed air;
a tool housing configured to substantially encompass the pneumatic device;
a regulator assembly connected into the tool housing, the regulator assembly being in fluid communication with the pneumatic device so as to regulate the pressure of compressed air operating the pneumatic device at the point of use of the pneumatic device; and
a coupling connected into the regulator assembly, the coupling being configured to couple to a supply of compressed air such that a flow of compressed air is substantially directed through the regulator assembly to the pneumatic device,
wherein the regulator assembly and the coupling are integrated into the tool housing.

2. The pneumatic tool of claim 1, wherein the regulator assembly is threaded into engagement with the tool housing.

3. The pneumatic tool of claim 1, wherein the coupling is threaded into engagement with the regulator

4. The pneumatic tool of claim 1, wherein the regulator includes an adjustable valve for varying the pressure of the flow of compressed air to the pneumatic device.

5. The pneumatic tool of claim 1, wherein the coupling is a quick connect pneumatic coupler.

6. The pneumatic tool of claim 1, wherein the pneumatic device is a pneumatic fastener.

7. The pneumatic tool of claim 1, wherein the regulator assembly includes a stop for defining a maximum acceptable pressure.

8. The pneumatic tool of claim 1, wherein the regulator assembly is substantially coaxially aligned with the coupling.

9. A pneumatic hand tool, comprising:
a pneumatic device constructed to perform a task under the influence of compressed air;
a regulator assembly in fluid communication with the pneumatic device, the regulator assembly being constructed to regulate the pressure of compressed air operating the pneumatic device at the point of use of the pneumatic device;
a coupling in fluid communication with the regulator assembly such that the flow of air is substantially directed through the regulator assembly to the pneumatic device, the coupling being configured for coupling to a supply of compressed air; and
a hand tool housing configured to encompass the pneumatic device and the regulator assembly,
wherein the hand tool housing is configured for being grasped by a user.

10. The pneumatic hand tool of claim 9, wherein the regulator includes an adjustable valve for varying the pressure of the flow of compressed air to the pneumatically operated device.

11. The pneumatic hand tool of claim 9, wherein the coupling is a quick connect pneumatic coupler.

12. The pneumatic hand tool of claim 9, wherein the pneumatic device is a pneumatic fastener.

13. The pneumatic hand tool of claim 9, wherein the regulator assembly includes a stop for defining a maximum acceptable pressure.

14. The pneumatic hand tool of claim 9, wherein the regulator assembly is substantially coaxially aligned with the coupling.

15. The pneumatic hand tool of claim 14, wherein the regulator assembly includes an adjustable valve for varying the pressure of the flow of compressed air to the pneumatic device.

16. The pneumatic hand tool of claim 14, wherein the regulator assembly includes:
a dial configured for manipulation by a user, the dial having a set of inwardly directed gear teeth;
a planet gear including gear teeth configured and arranged to intermesh with the gear teeth included on the dial;
a sun gear including gear teeth configured and arranged to intermesh with the gear teeth included on the planet gear, and
a valve mechanism coupled with the sun gear such that rotation of the sun gear changes the pre-selected tool pressure.

17. A pneumatic fastener, comprising:
a pneumatic driver configured to drive a fastener into a workpiece;
an adjustable regulator assembly in fluid communication with the pneumatic driver, the regulator assembly being constructed to adjustably regulate the pressure of compressed air operating the pneumatic driver at the point of use of the pneumatic driver;
a coupling in fluid communication with the regulator assembly such that the flow of air is substantially directed through the regulator assembly to the pneumatically driver, the coupling being configured for coupling to a supply of compressed air; and
a housing configured to encompass the pneumatic driver and the regulator assembly,
wherein the regulator is coaxially aligned with the coupling.

18. The pneumatic fastener of claim 17, wherein the coupling is a quick connect pneumatic coupler.

19. The pneumatic fastener of claim 17, wherein the regulator assembly includes a stop for defining a maximum acceptable pressure.

20. The pneumatic fastener of claim 17, wherein the regulator assembly includes:
a dial configured for manipulation by a user, the dial having a set of inwardly directed gear teeth;
a planet gear including gear teeth configured and arranged to intermesh with the gear teeth included on the dial;
a sun gear including gear teeth configured and arranged to intermesh with the gear teeth included on the planet gear, and
a valve mechanism coupled with the sun gear such that rotation of the sun gear changes the pre-selected tool pressure.

21. A pneumatic fastener, comprising:
a pneumatic driver configured to drive a fastener into a workpiece;
means for regulating the pressure of compressed air operating the pneumatic driver at the point of use of the pneumatic driver; and
a housing configured to substantially encompass the pneumatic driver and the regulating means.

22. A pneumatic hand tool, comprising:
a pneumatic device constructed to perform a task under the influence of compressed air;
means for regulating the pressure of compressed air operating the pneumatic driver at the point of use of the pneumatic device; and
a hand tool housing configured to substantially encompass the pneumatic device and the regulating means.
